(19) United States
(12) Patent Application Publication
(10) Pub. No.: US 2009/0275869 A1
(43) Pub. Date: Nov. 5, 2009

(54) MASSAGE DEVICE

(76) Inventor: Jill Robin Payne, Houston, TX (US)

Correspondence Address: John Douglas, 3600 College Park Drive , Apt. 5305, The Woodlands, TX, 77384, US

(21) Appl. No.: 12/454,529

(22) Filed: May 19, 2009

Related U.S. Application Data
(63) Continuation-in-part of application No. 11/300,913, filed on Dec. 15, 2005, now abandoned.
(60) Provisional application No. 60/636,149, filed on Dec. 15, 2004.

(51) Int. Cl. A61H 7/00

(52) U.S. Cl. 601/135

(57) ABSTRACT

The present invention is a massage device having a flexible housing, typically pseudo-spherical in shape and one to five inches in diameter, the housing having at least one chamber containing a plurality of internal elements which are typically pseudo-spherical in shape and one-half to one inch in diameter.

### CROSS-REFERENCE TO RELATED APPLICATIONS

The present application is a continuation-in-part of U.S. utility patent application Ser. No. 11/300,913, having a filing date of Dec. 15, 2005, which claims priority to U.S. provisional patent application No. 60/636,149 by Jill Robin Payne having a filing date of Dec. 15, 2004.

### FIELD

The present invention generally relates to the field of massage and massage therapy and in particular to devices used for massage treatments of the feet, back and other areas of the human body.

### BACKGROUND

Various devices have been used in the area of massage therapy for the reduction of undesirable symptoms such as pain and stress and also for the pleasurable physical response that massage can bring about.

U.S. Pat. No. 5,830,163 to Obermaier discloses an inflatable foot massage apparatus comprising two spaced-apart fluid filed chambers. The chambers can be used by the individual to massage each foot separately.

U.S. Pat. No. 6,200,283 to Groen discloses a reflex zone massage stimulator comprising a rotatable rod-like element having projections that can be brought into contact with the skin of the user. The user uses the rod-like element in a rolling motion over the desired area of the body to be massaged, such as the bottom of a foot.

U.S. Pat. No. 6,506,173 to Gordon discloses a flexible massaging pad having pressure points for massaging a foot or feet of a user. The pressure points on the pad are located in specific zones to enable the massage of one or several areas of the foot at a time.

The discussion of issued patents does not mean that the inventions or features contained herein are in the general body of public knowledge.

The applicant believes that the present invention possesses distinctions over what is known in the art and possesses advantages over what has been previously available.

### SUMMARY

The present invention is directed to a massage device that can be used advantageously to apply pressure to the human body in a manner with sufficient resistance as to promote desired responses such as the reduction of stress and/or pain symptoms.

### BRIEF DESCRIPTION OF DRAWINGS

FIG. 1 is a schematic side view according to one embodiment of the invention.

FIG. 2 is a side view of an embodiment of the invention.

FIG. 3 is a side view of one embodiment, where the invention is attached to the outside of a sock.

FIG. 4 is a side view of one embodiment, where the invention is enclosed within a sock.

FIG. 5 is a front view of an embodiment of the invention incorporating a foot rest.

FIG. 6 is a top view of an embodiment of the invention incorporating a foot rest.

### DETAILED DESCRIPTION

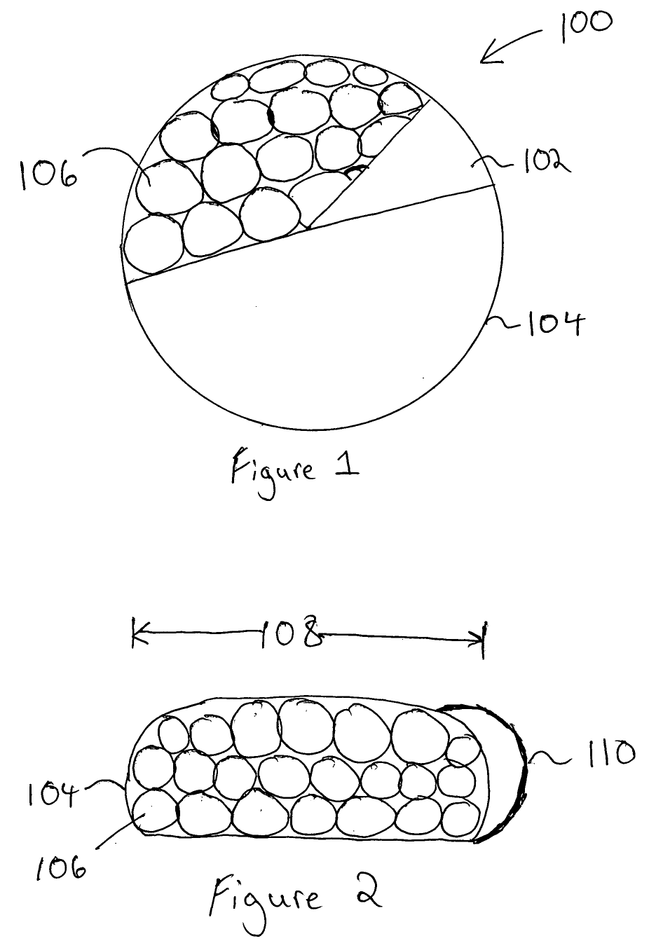

The invention will be described by way of examples with reference to FIGS. 1 and 2, which are not to be construed as a limitation upon the apparatus elements of the invention. The present invention is directed to a massage device. In some embodiments the invention can function as a foot massage device. Embodiments of the present invention can be used as a body massage device for example, back massage, leg massage, neck massage and the like.

The present invention is characterized in that the active surface can provide massage pressure where desired and with sufficient resistance as to provide relief to the muscles and other bodily tissues and promote reduced pain and fatigue, while promoting increased blood circulation and other positive physical responses.

Referring to FIGS. 1 and 2, there is provided an embodiment of a massage device 100 consisting of one or more chambers 102 contained within a flexible housing 104 that contains the plurality of internal elements 106 of the device. The flexible housing 104 can be of a spherical, cylindrical, kidney-shaped or other design that facilitates the support of the internal elements 106. The flexible housing 104 can also be of other shapes such as, for example, cubic, conic, pyramid and other prismatoids as well as polyhedrons and combinations thereof.

The flexible housing 104 can be made of various fabrics, colors, textures, and patterns, such as for example, leather, animal skin, fur, stretchable fabrics such as Lycra®, cotton and tapestry material. The flexible housing 104 can also have adornments such as tassels, sequins, fur, hair, or strands of material attached to simulate fur or hair.

The one or more chambers 102 contain a plurality of the internal elements 106 that can be spherical or pseudo-spherical in shape. Within the present application the term pseudo-spherical will be used to describe elements having an overall spherical, round or otherwise globular shape, but is not meant to limit the shape of the elements to only objects having a near perfect roundness. The shape can include, but is not limited to, oblate spheroids, prolate spheroids, ovoid and obovoid objects. The internal elements 106 can include marbles, balls, stones, beans or other similarly shaped objects and combinations thereof. Internal elements having shape other than perfect roundness can increase the resistance to movement of two elements as they are in contact with each other, resulting in a frictional resistance of the two elements to roll past each other. This result can be used within the massage device to impart an elevated amount of massage pressure upon the body area being treated. The number of internal elements having a shape other than perfect roundness can be adjusted to give a certain resistance level to the massage device.

The internal elements 106 can be of an average diameter of one-quarter inch up to one and one-half inch. One desirable size range for the internal elements is when the majority of the elements range from one-half to three-quarter inch in diameter.

The internal elements can consist of marbles made of glass, ceramic or other material. The material has to be of sufficient hardness that the normal use of the massage device does not substantially fragment the internal elements. One desirable size range is when the internal elements consist primarily of the common marble size of approximately five-eighths inch diameter. In one embodiment of the invention the internal elements consist of marbles of the “common” size of approximately five-eighths inch diameter and of marbles of the “shooter” size of approximately three-fourths inch diameter.

The internal elements can have an outer surface that is smooth, as in a typical marble. The internal elements can alternatively have a non-smooth surface, for example as in marbles, stones or other materials that can have pits, crevices, protrusions and/or ridges on its external surfaces. A non-smooth surface can increase the resistance of the two elements as they are in contact with each other, resulting in a frictional resistance of the two elements to roll past each other when in contact. This result can be used within the massage device to impart an elevated amount of massage pressure upon the area being treated. The number of internal elements having a non-smooth surface can be adjusted to give a certain resistance level to the massage device.

In one embodiment the flexible housing 104 is used to contain the internal elements with sufficient force as to have the internal elements stack upon themselves and to provide more than one layer of internal elements within the massage device. The multiple layers of internal elements within the massage device enable the user to exert massage pressure to the body as the internal elements can move past each other, thereby a plurality of internal elements alternatively are in indirect contact, through the flexible housing, with the area receiving treatment.

In an alternative embodiment the flexible housing 104 is used to contain the internal elements with sufficient force as to have the internal elements form a single layer of internal elements within the massage device. In this embodiment, the single layer of internal elements provide the massage pressure to the area receiving treatment.

Referring now to FIG. 2, a cross sectional view, in one embodiment the flexible housing 104 of the massage device can have a pseudo-spherical shape. The massage device will generally range from one to five inches in diameter 108, thereby being portable in nature and able to be held and used with a single hand. In one embodiment a holding/attachment means 110 can be attached to the flexible housing 104 which can facilitate the holding and use of the massage device, for example, by enabling a users hand to fit between the holding/attachment means 110 and the flexible housing 104. One desirable embodiment of the massage device will be of approximately two to three inches in diameter 108.

In an embodiment, the internal elements 106 form stacked layers in the massage device 100 such that the internal elements have a total height within the flexible housing 104 resulting in at least a portion of the flexible housing having constant contact with at least a portion of the top layer 114 of the stacked internal elements during use. The internal elements may occupy all of the interior volume of the one or more chambers, except for the unoccupied volume, also referred to as void volume, resulting from the contact between the internal elements due to their shape.

As the massage device 100 is set on a floor or other surface it generally holds its pseudo-spherical shape and has multiple vertical layers of the internal elements contained within it. If the massage device is put in contact with an area of the human body, for example the bottom of a foot being pressed down upon the massage device, the massage device will impart pressure upon the contact area of the foot. If the foot is both pressed down and moved horizontally, the massage device will impart pressure upon the contact area of the foot and the internal elements will roll past one another with a certain degree of resistance, thereby imparting a moving and/or rolling pressure, herein referred to as stacked resistance, upon the contact area of the foot in a manner consistent with massage therapy. The user can adjust the massage therapy, both the pressure and movement that is received by altering the amount of downward pressure imparted by the foot and the horizontal movements made by the foot.

The housing 104 is flexible thereby enabling the movement of the internal elements within the massage device. The flexible housing can enable a certain degree of compaction of the massage device but in most embodiments should be of sufficient tightness that more than one layer of internal elements remain throughout its use. If compaction of the massage device is to the point of only one layer of internal elements the resistance imparted to the user will only be that of a single internal element and not the stacked resistance that is developed with multiple layers, but will still impart massage pressure to the area of contact.

In one embodiment the massage device 100 can be attached to or enclosed within a sock. The massage device 100 can be located to the underside of or within the sole of the sock such that when a user is wearing the sock the massage device 100 is positioned under the foot.

In an alternate embodiment at least one massage device 100 can be attached to or enclosed within a foot rest. In an aspect two massage devices, one for each foot, can be attached or enclosed within a foot rest. The foot rest with the massage device 100 can then be located to enable use of the massage device 100, such as in front of a chair or under a desk. The foot rest can comprise an inclined or elevated design to position the massage device 100 at a desirable height.

The number of internal elements within the massage device can vary depending on the size of the massage device and the size of the internal elements. When the internal elements are of the general size of a common marble, the number can range from 10 to 100. For one embodiment of the massage device 100 ranging from 2.5 to 3 inches in diameter in diameter 108, the internal elements can range from 25 to 75 in number. In another embodiment the number of internal elements can range from 30 to 50.

An important aspect of the massage device 100 is the diameter size of the internal elements 106 in relation to the diameter size of the massage device itself. This aspect determines how the massage device behaves under physical pressure and the type of massage therapy that is imparted to the user. In an embodiment, the ratio of the diameter size of the massage device 100 in relation to the diameter size of the internal elements 106 ranges from about 2:1 to about 20:1. In another embodiment, the diameter size ratios range from about 5:1 to about 15:1.

In an embodiment, all of the internal elements have the same size of diameter. In another aspect, each of the internal elements comprises the same material, such as glass, plastic, or other solid material. In another embodiment, each internal element has the same mass.

In another embodiment, the massage device is capable of conforming to a palm of a human hand. In another aspect, the massage device is capable of conforming to a sole of a human foot. The size and/or shape of the massage device of the current invention may be selected such that, during use, the entire massage device contours to a palm of a hand or a sole of a foot.

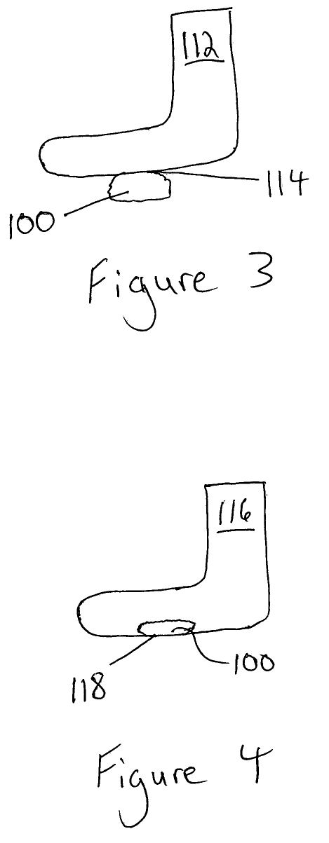

Referring to FIG. 3, a side view, in one embodiment the massage device 100 is attached to the bottom 114 of a sock 112. Referring to FIG. 4, a side view, in another embodiment the massage device 100 is enclosed within the sole 118 of a sock 116.

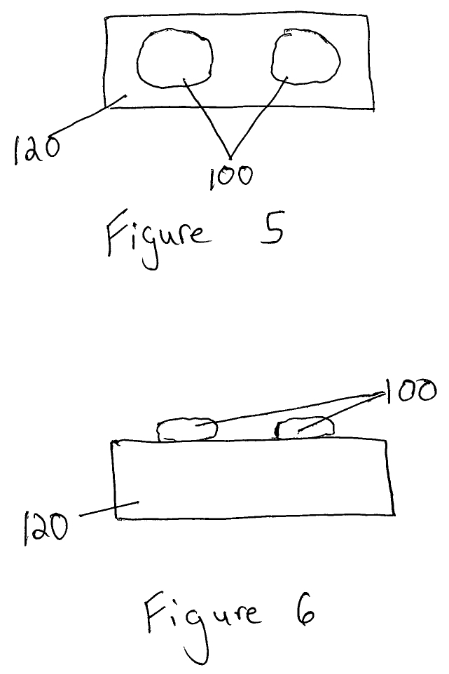

Referring to FIGS. 5 and 6, in one embodiment massage device 100 is attached in two places to a foot rest 120. FIG. 5 represents the top view of foot rest 120 incorporating the massage device 100, and FIG. 6 represents the front view of foot rest 120 incorporating the massage device 100.

Within the present application the terms “comprise”, “comprising” and “comprises” shall have a non-exclusive meaning and that if an embodiment is said to comprise a certain feature the embodiment will have that feature but is not restricted in any way as to other features the embodiment may have.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A massage device comprising:
A flexible housing;
one or more chambers;
the chambers contain a plurality of internal elements; and
wherein the internal elements occupy all of the interior volume of the one or more chambers, except for any empty space resulting from contact between the internal elements due to their shape.

2. The apparatus of claim 1, wherein the massage device has a size such that, during use, the entire massage device contours to the palm of a hand.

3. The apparatus of claim 1, wherein the massage device has a size such that, during use, the entire massage device contours to the sole of a foot.

4. The apparatus of claim 1, wherein the flexible housing contains the internal elements with sufficient force such that the internal elements stack upon themselves and to provide more that one layer of internal elements within the massage device.

5. The apparatus of claim 1, wherein the internal elements are pseudo-spherical in shape.

6. The apparatus of claim 1, the ratio of the diameter of the massage device in relation to the diameter of the internal elements ranges from about 2:1 to about 20:1.

7. The apparatus of claim 1, the ratio of the diameter of the massage device in relation to the diameter of the internal elements ranges from about 5:1 to about 15:1.

8. The apparatus of claim 1, wherein all of the internal elements have the same diameter size.

9. The apparatus of claim 1, wherein all of the internal elements consist of the same material.

10. The apparatus of claim 1, wherein at least a portion of the internal elements have a non-smooth surface.

11. The apparatus of claim 1, wherein the internal elements range in number from 10 to 100.

12. The apparatus of claim 1, wherein the internal elements range in number from 25 to 75.

13. The apparatus of claim 1, wherein the internal elements range in number from 30 to 50.

14. The apparatus of claim 1, wherein the massage device is attached to a sock such that the massage device is located under the foot of a wearer of the sock.

15. The apparatus of claim 1, further comprising a holding/attachment means.

16. The apparatus of claim 15, wherein the holding/attachment means comprises a handle to enable a user to hold the massage device.

17. The apparatus of claim 1, wherein the massage device is attached to a foot rest such that a user can utilize the massage device while seated.

18. A massage device comprising:
a flexible housing of pseudo-spherical shape from two to three inches in diameter, the housing containing internal elements with sufficient force such that the internal elements stack upon themselves and to provide more than one layer of internal elements within the message device;
one or more chambers within the housing containing a plurality of internal elements;
wherein the internal elements are pseudo-spherical in shape, range from one-quarter to one inch in diameter, and range in number from 30 to 50; and
wherein the stacked layers of internal elements have a total height within the flexible housing such that at least a portion of the flexible housing remains in constant contact with at least a portion of the top layer of the stacked internal elements during use.

19. The apparatus of claim 18, wherein all of the internal elements have the same diameter size.

20. The apparatus of claim 19, the ratio of the diameter of the massage device in relation to the diameter of the internal elements ranges from about 2:1 to about 20:1.
